(19) United States
(12) Patent Application Publication
(10) Pub. No.: US 2014/0355027 A1
(43) Pub. Date: Dec. 4, 2014

(54) Image Forming Apparatus with High Security for Individual Information

(71) Applicant: Kyocera Document Solutions Inc., Osaka (JP)

(72) Inventor: Sumio Yamada, Osaka (JP)

(73) Assignee: Kyocera Document Solutions Inc., Osaka (JP)

(21) Appl. No.: 14/292,875

(22) Filed: May 31, 2014

(30) Foreign Application Priority Data
May 31, 2013 (JP) 2013-114939

(51) Int. Cl. H04N 1/00; H04N 1/44

(52) U.S. Cl. CPC H04N 1/00864; H04N 1/4473; H04N 1/4446
USPC 358/1.13

(57) ABSTRACT

An image forming apparatus includes a document reading unit, an individual information recognition unit, an individual information storage unit, an approval-use paper-sheet-personal-information identification unit, and an image forming unit. The individual information recognition unit is configured to recognize character data of individual information and appraisal data to identify individual information from image data when a paper sheet is for individual information recordation. The approval-use paper-sheet-personal-information identification unit is configured to collate image data of a signature space on the paper sheet for approval against the appraisal data stored in the individual information storage unit when a paper sheet read by the document reading unit is a paper sheet for approval to identify matching individual information. The image forming unit is configured to image the character data of identified individual information at a predetermined position on the paper sheet for approval when individual information is identified.

### CROSS-REFERENCE TO RELATED APPLICATION

This application is based upon, and claims the benefit of priority from, corresponding Japanese Patent Application No. 2013-114939 filed in the Japan Patent Office on May 31, 2013, the entire contents of which are incorporated herein by reference.

### BACKGROUND

Unless otherwise indicated herein, the description in this section is not prior art to the claims in this application and is not admitted to be prior art by inclusion in this section.

There is provided an image forming apparatus such as a multifunctional peripheral (MFP), which can print documents and images. With such image forming apparatus, in cases of application for travel or a similar purpose and a business talk on a vehicle, a house, or a similar purchase, a paper sheet such as an estimation, an application form, and a contract that include spaces to which individual information such as an address, a telephone number, and a name are to be described may be printed.

The image forming apparatus includes a print system having a storage medium, an application form, and a print apparatus. The storage medium stores itemized individual information formed of equal to or more than one items. The application form requires a description of the individual information. The print apparatus reads the individual information, which is stored in the storage medium, and prints the individual information on the application form. The application form includes entry item information and an information storage unit. The entry item information relates to an entry item of the application form. The information storage unit stores application form information that includes print position information regarding a print position of the respective entry items. The print apparatus includes an application form information acquisition unit, an individual information acquisition unit, a print item extraction unit, and a print unit. The application form information acquisition unit reads data in the information storage unit attached to the application form to obtain the application form information. The individual information acquisition unit reads the individual information from the storage medium to obtain the individual information. The print item extraction unit collates the entry item information and the individual information. The print item extraction unit extracts a corresponding item as a print item. The print unit prints individual information corresponding to the print item based on the print position information. This technique can read individual information stored in a special storage medium such as an IC chip appended to a paper sheet of application form or a user's mobile phone and fill the individual information in the paper sheet when printing the paper sheet. This eliminates the labor of a user filling in required items by hand on his/her own. This can improve work efficiency of filling work to the application form and also can reduce a load of the user.

### SUMMARY

An image forming apparatus according to the disclosure includes a document reading unit, an individual information recognition unit, an individual information storage unit, an approval-use paper-sheet-personal-information identification unit, and an image forming unit. The document reading unit is configured to read a paper sheet containing a space written into by hand as image data. The individual information recognition unit is configured to recognize character data of individual information and appraisal data to identify individual information from image data of an individual information recordation space in the paper sheet for individual information recordation when a paper sheet read by the document reading unit is for individual information recordation. The individual information storage unit is configured to store the character data of individual information and the appraisal data recognized by the individual information recognition unit. The approval-use paper-sheet-personal-information identification unit is configured to collate image data of a signature space on the paper sheet for approval against the appraisal data stored in the individual information storage unit when a paper sheet read by the document reading unit is a paper sheet for approval to identify matching individual information. The image forming unit is configured to image the character data of identified individual information at a predetermined position on the paper sheet for approval when individual information is identified by the approval-use paper-sheet-individual information identification unit.

These as well as other aspects, advantages, and alternatives will become apparent to those of ordinary skill in the art by reading the following detailed description with reference where appropriate to the accompanying drawings. Further, it should be understood that the description provided in this summary section and elsewhere in this document is intended to illustrate the claimed subject matter by way of example and not by way of limitation.

### BRIEF DESCRIPTION OF THE DRAWINGS

FIG. 1 illustrates a system constitution of an image forming apparatus and a server according to one embodiment of the disclosure;

FIG. 2 illustrates a control configuration of the image forming apparatus and the server according to the one embodiment;

FIG. 3 schematically illustrates the image forming apparatus according to the one embodiment;

FIG. 4 illustrates an individual information recordation process according to the one embodiment;

FIG. 5 illustrates an exemplary temporary individual information recordation card employed for the individual information recordation process according to the one embodiment;

FIG. 6 illustrates a definitive recordation and a destruction process according to the one embodiment;

FIGS. 7A and 7B are exemplary documents for approval employed for the definitive recordation and the destruction process according to the one embodiment; and

FIG. 8 is an exemplary individual information destruction card employed for the definitive recordation and the destruction process according to the one embodiment.

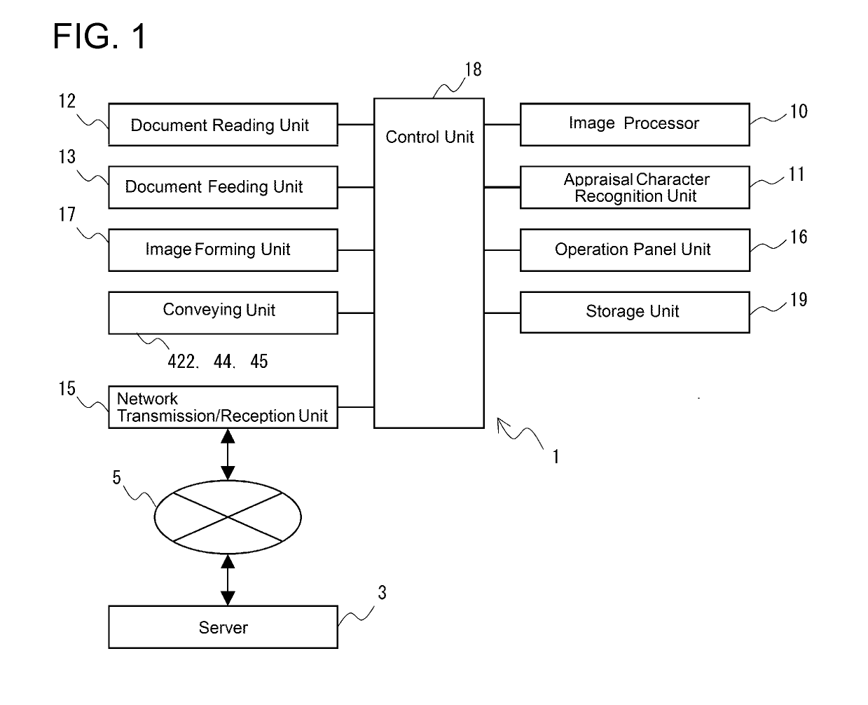

### DETAILED DESCRIPTION

Example apparatuses are described herein. Other example embodiments or features may further be utilized, and other changes may be made, without departing from the spirit or scope of the subject matter presented herein. In the following detailed description, reference is made to the accompanying drawings, which form a part thereof.

The example embodiments described herein are not meant to be limiting. It will be readily understood that the aspects of the present disclosure, as generally described herein, and illustrated in the drawings, can be arranged, substituted, combined, separated, and designed in a wide variety of different configurations, all of which are explicitly contemplated herein.

### Configuration of Image Forming Apparatus 1 According to Embodiment

In an image forming apparatus 1, an image processor 10, an appraisal character recognition unit 11, a document reading unit 12, a document feeding unit 13, a conveying unit, (a paper feed roller 422, a conveyance roller 44, a discharge roller 45), a network transmission/reception unit 15, an operation panel unit 16, a storage unit 19, an image forming unit 17 (an image formation unit), or a similar unit are connected to a control unit 18. The control unit 18 operates and controls the respective units.

An image processor 10 is an operation control unit, such as Digital Signal Processor (DSP) and Graphics Processing Unit (GPU). The image processor 10 performs specific image processing on image data, for example, the image processor 10 performs various image processing such as scaling, density adjustment, tone adjustment, and image enhancement processing. The image processor 10 converts an image read by the document reading unit 12 into a file unit in a PDF, TIFF, or a similar format, and stores the image as the image data 500 in the storage unit 19.

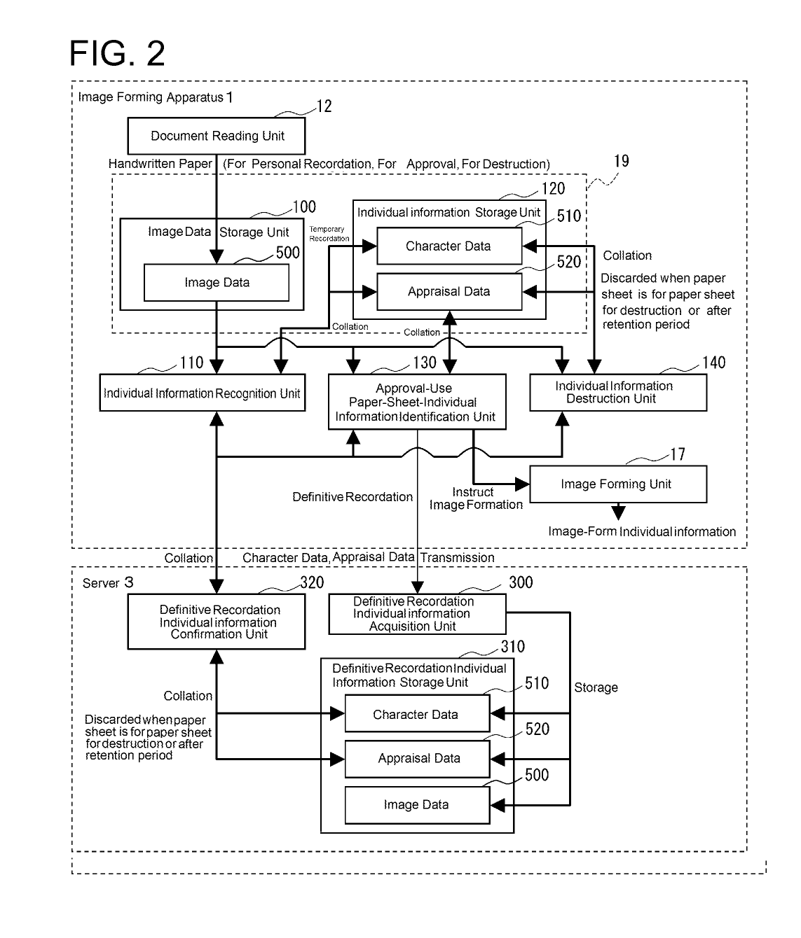

The appraisal character recognition unit 11 is an operation control unit such as a DSP to perform Optical Character Reader (OCR), optical character recognition, pattern recognition, and color recognition. The appraisal character recognition unit 11 extracts a line segment, feature value information, or similar information from image data 500 (see FIG. 2) read by the document reading unit 12 and image-processed by the image processor 10. Then, the appraisal character recognition unit 11 recognizes characters, drawing, or similar data written by hand or printed. The appraisal character recognition unit 11 can recognize various data embedded in an image such as one-dimensional and two-dimensional barcodes, a color pattern, a geometric pattern, and watermark data. Thus, the appraisal character recognition unit 11 can recognize a type of a paper sheet such as paper sheets for recordation and for approval of individual information and a paper sheet for destruction of individual information from, for example, various data embedded in the image data 500. The appraisal character recognition unit 11 may recognize the type of paper sheet by optical character recognition. The appraisal character recognition unit 11 can recognize frames, tables, or a similar format. The appraisal character recognition unit 11 can also recognize a recordation space for individual information, a signature space including a seal space, or a similar space. The appraisal character recognition unit 11 also performs a predetermined feature value extraction operation on the recognized characters, graphics, or similar data. Thus, the appraisal character recognition unit 11 calculates a feature value of handwriting such as an inclination and a connection of line segment. This feature value of handwriting can be employed for appraisal for identifying individual information. The appraisal character recognition unit 11 can also calculate a feature value of imprint of a seal image. The appraisal character recognition unit 11 can also recognize characters written by hand, printed characters, various data, or similar data at every coordinate set as respective spaces according to paper sheet information (not illustrated) stored in the storage unit 19.

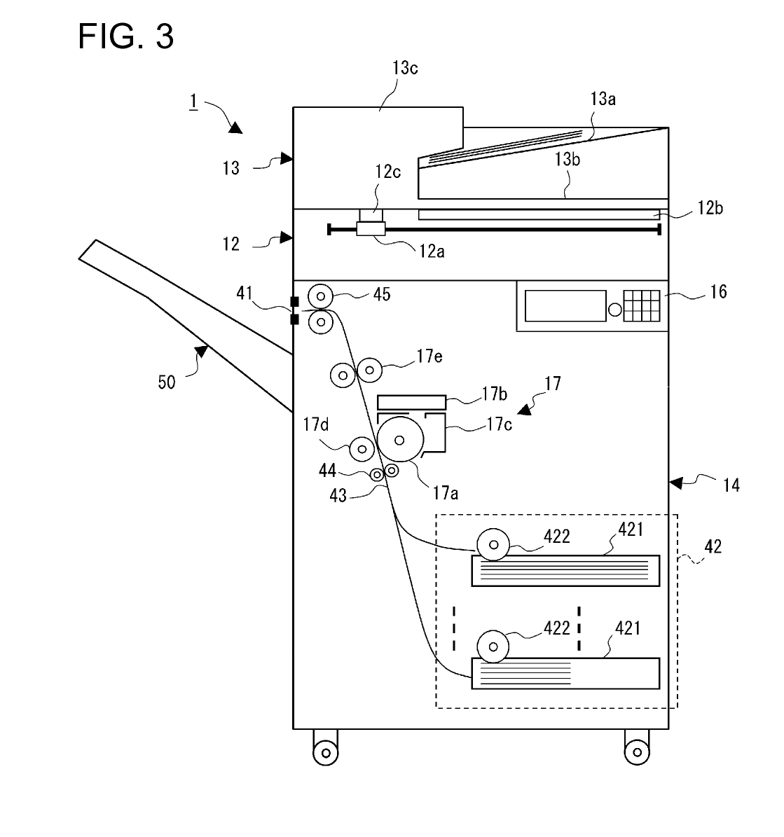

The document reading unit 12 is a unit for reading (scan) a document such as a set paper sheet. The document feeding unit 13 is a unit for conveying a document to be read by the document reading unit 12. The image forming unit 17 is a unit for performing image formation from data such as data obtained from a server 3, stored in the storage unit 19, and read by the document reading unit 12 to a recording sheet by an output instruction by a user. The conveying units (422, 44, 45) convey the recording sheet from a sheet feed cassette 421 (see FIG. 3). The conveying unit causes the image forming unit 17 to form an image and then conveys the image to a stack tray 50. Operations of the document reading unit 12, the document feeding unit 13, the conveying units (422, 44, 45), and the image forming unit 17 will be described later.

The network transmission/reception unit 15 is a network connection unit that includes a LAN broad to connect to the network 5, a wireless transceiver, or a similar unit. The network 5 includes wired or wireless Internet, an intranet, a mobile network, or a similar network. With the network transmission/reception unit 15, a circuit for data communications transmits and receives data, and a voice telephone circuit transmits and receives speech signal. The image forming apparatus 1 is connected to the server 3 from the network transmission/reception unit 15 via the network 5. The server 3 is a server such as a general PC/AT-compatible machine. The server 3 includes a control unit such as a CPU; a storage unit such as a HDD, SSD, ROM, and RAM; and a network connection unit.

The operation panel unit 16 includes a display unit such as an LCD and an input unit such as a button and a touch panel. The button and touch panel include a numeric keypad, a button for switching an operation mode such as start, cancel, copy, FAX transmission, scanner, or a similar operation, a button for executing an instruction regarding execution of job on print, transmission, storage, recording, or a similar operation of a selected document. The operation panel unit 16 obtains instructions of various jobs of the image forming apparatus 1 by the user. User instructions obtained from the operation panel unit 16 can input and change information on respective users.

The control unit 18 is an information processing unit such as a General Purpose Processor (GPP), Central Processing Unit, (CPU), a Micro Processing Unit (MPU), a Digital Signal Processor (DSP), a Graphics Processing Unit (GPU), an Application Specific Processor (ASIC). The control unit 18 reads the control program stored in the ROM and the HDD in the storage unit 19. Loading the control program to the RAM and executing the control program operates the control unit 18 as respective units of function block described later. Thus, the control unit 18 controls the entire apparatus according to predetermined instruction information input from the server 3 and the operation panel unit 16.

The storage unit 19 is a storage unit using a semiconductor memory, such as a Read Only Memory (ROM) and a Random Access Memory (RAM), and a recording medium such as a Hard Disk Drive (HDD). The ROM and HDD of the storage unit 19 store control programs for operating and controlling the image forming apparatus 1. The storage unit 19 also includes an image data storage unit 100 (see FIG. 2) and an individual information storage unit 120 (see FIG. 2). The image data storage unit 100 is a region where the image data 500, which is scanned by the document reading unit 12 and image-processed by the image processor 10, is stored. The individual information storage unit 120 is a region for storing individual information. The storage unit 19 also stores data such as print document data transmitted from a user's terminal (not illustrated) and various files and thumbnail image data read out from the recording medium.

The image forming apparatus 1 may integrally form the control unit 18 and the image processor 10 like, for example, a GPU built-in CPU and a chip-on-module package. The appraisal character recognition unit 11 may be achieved by executing the control program, which is stored in the storage unit 19, by the control unit 18 or the image processor 10. The control unit 18 and the image processor 10 may have a memory such as a RAM, a ROM, and a flash memory built in. The image forming apparatus 1 may include a FAX transceiver unit to perform transmitting and receiving facsimile.

### Constitution of Image Forming Apparatus 1 and Server 3

Here, the following describes functional configurations of the image forming apparatus 1 and the server 3 of the embodiment with reference to FIG. 2. The image forming apparatus 1 and the server 3 constitute an image forming system. The image forming apparatus 1 includes the document reading unit 12, the image forming unit 17, the image data storage unit 100, an individual information recognition unit 110, the individual information storage unit 120, an approval-use paper-sheet-individual information identification unit 130, and an individual information destruction unit 140. The server 3 includes a definitive recordation individual information acquisition unit 300, a definitive recordation individual information storage unit 310, and a definitive recordation individual information confirmation unit 320.

The image data storage unit 100 is a storage region or a similar region configured in the storage unit 19. The image data storage unit 100 stores the image data 500 read by the document reading unit 12.

When the appraisal character recognition unit 11 recognizes the image data 500 on the paper sheet read by the document reading unit 12 as a paper sheet for individual information recordation, the individual information recognition unit 110 causes the appraisal character recognition unit 11 to recognize characters written by hand, an imprint, or similar description from a location corresponding to the individual information recordation space in the image data 500. Then, the individual information recognition unit 110 causes the appraisal character recognition unit 11 to create character data 510 of individual information and appraisal data 520 to identify individual information.

The individual information storage unit 120 is a database configured in the storage unit 19. The individual information storage unit 120 stores the character data 510 of individual information and the appraisal data 520 recognized by the individual information recognition unit 110.

When the appraisal character recognition unit 11 recognizes the image data 500 on the paper sheet read by the document reading unit 12 as a paper sheet for approval, the approval-use paper-sheet-individual information identification unit 130 causes the appraisal character recognition unit 11 to calculate a feature value or a similar value from a location corresponding to a signature space on the image data 500. Then, the approval-use paper-sheet-individual information identification unit 130 collates the feature value against the appraisal data 520 stored in the individual information storage unit 120 to identify matching individual information.

When the appraisal character recognition unit 11 recognizes the image data 500 on the paper sheet read by the document reading unit 12 as a paper sheet for destruction of individual information, the individual information destruction unit 140 causes the appraisal character recognition unit 11 to calculate a feature value or a similar value from the location corresponding to the signature space on the image data 500. Then, the individual information destruction unit 140 collates the feature value against the appraisal data 520 stored in the individual information storage unit 120. When matching individual information is identified, the individual information destruction unit 140 destroys the character data 510 of individual information and the appraisal data 520 stored in the individual information storage unit 120. If a predetermined retention period has passed from when the character data 510 of individual information and the appraisal data 520 are stored in the individual information storage unit 120, the individual information destruction unit 140 also destroys the character data 510 and the appraisal data 520. Since individual information is not required in cases of not agreeing an application, a business talk, or a similar situation, the individual information stored in the individual information storage unit 120 needs to be destroyed. In view of this, when the individual information destruction unit 140 fails to read a signed paper sheet for approval, the individual information destruction unit 140 automatically destroys the individual information after a lapse of the predetermined retention period. When a business talk or a similar talk has been held for a plurality of days, the information needs to be held. Therefore, the predetermined retention period can be set to each of the individual information.

The definitive recordation individual information acquisition unit 300 obtains the image data 500 on the paper sheet for approval, the character data 510 of individual information, and the appraisal data 520, which are identified from the image data 500 by the approval-use paper-sheet-individual information identification unit 130, from the image forming apparatus 1.

The definitive recordation individual information storage unit 310 is, for example, a database for definitive recordation. The definitive recordation individual information storage unit 310 stores the image data 500 on the paper sheet for approval, the character data 510 of individual information, and the appraisal data 520. In this respect, a time stamp, an electronic certificate, or similar data may be added to these data.

The definitive recordation individual information confirmation unit 320 obtains queries whether individual information is stored or not, from the individual information recognition unit 110 and the approval-use paper-sheet-individual information identification unit 130 of the image forming apparatus 1. Then, when the definitive recordation individual information storage unit 310 stores the character data 510 and the appraisal data 520 corresponding to the obtained individual information, that is, the individual information is identified, the definitive recordation individual information confirmation unit 320 notifies the information. The definitive recordation individual information confirmation unit 320 can also transmit the stored character data 510 and appraisal data 520 to the image forming apparatus 1.

### Constitution of Data in Image Forming Apparatus 1 and Server 3

The image data 500 is image data read by the document reading unit 12 and image-processed by the image processor 10. The image data 500 is a file such as a file of a bitmap image with an RGB color, monochrome, or a grey scale; and a file slightly compressed by run length, an LZW, or a similar method. The image data 500 may be data already converted into a format such as a PDF and TIFF by the image processor 10 and the control unit 18. The image data 500 may be a file scanned in advance and stored in a recording medium prepared by the user or a similar file.

The character data 510 is character data recognized at the appraisal character recognition unit 11 by the individual information recognition unit 110. The character data 510 includes individual information data such as a postcode, an address, a telephone number, a mobile phone number, an e-mail address, and a name, which are read by the appraisal character recognition unit 11 using optical character recognition on the locations of entry columns of the image data 500 written by hand on the paper sheet for personal recordation. The character data 510 includes data such as data of the predetermined retention period until the individual information described in the paper sheet for personal recordation is destroyed. A user, an administrator, or a similar person who wrote the individual information on the paper sheet can change the character data 510 after confirmation on the operation panel unit 16 of the image forming apparatus 1 and the server 3.

The appraisal data 520 is data of feature value of handwriting, an imprint, or a similar feature. The appraisal data 520 is data for identifying individual information recognized at appraisal character recognition unit 11 by the individual information recognition unit 110. The appraisal data 520 may include data indicative of a type of handwriting and imprint. The appraisal data 520 may include data such as a signature, a password, and a barcode employed for identifying individual information in addition to handwriting and imprint data. The appraisal data 520 is used for identifying individual information and authenticating the user. This ensures preventing impersonation by another person or a similar incident.

Here, by executing the control program stored in the storage unit 19, the control unit 18, the image processor 10, and the appraisal character recognition unit 11 of the image forming apparatus 1 function as the individual information recognition unit 110, the approval-use paper-sheet-individual information identification unit 130, and the individual information destruction unit 140, respectively. The storage unit 19 of the image forming apparatus 1 functions as an image data storage unit that holds the region in the image data storage unit 100. The storage unit 19 functions as an individual information storage unit that stores the character data 510 and the appraisal data 520 in the individual information storage unit 120. By executing the control program stored in the storage unit by a control unit, the control unit of the server 3 functions as the definitive recordation individual information acquisition unit 300 and the definitive recordation individual information confirmation unit 320. The storage unit of the server 3 functions as a definitive recordation individual information storage unit that stores the character data 510 and the appraisal data 520 in the definitive recordation individual information storage unit 310. The respective units of the above-described image forming apparatus 1 and server 3 become hardware resources that execute the image forming method of the disclosure.

### Operations of Image Forming Apparatus 1

Next, with reference to FIG. 3, the following describes operations of the image forming apparatus 1 according to the embodiment of the disclosure. The document reading unit 12 is arranged at an upper portion of a main unit 14. The document feeding unit 13 is arranged at an upper portion of the document reading unit 12. The stack tray 50 is arranged at a discharge port 41 for a recording sheet side formed at the main unit 14. The operation panel unit 16 is arranged at a front side of the image forming apparatus 1.

The document reading unit 12 includes a scanner 12a, a platen glass 12b, and a document reading slit 12c. The scanner 12a is constituted of an exposing lamp, Charge Coupled Device (CCD) and Complementary Metal Oxide Semiconductor (CMOS) imaging sensors, or a similar component and is configured to be movable to the document conveyance direction by the document feeding unit 13. The platen glass 12b is a document platen that is constituted of transparent materials, such as glass. The document reading slit 12c includes a slit that is formed in a direction perpendicular to a document conveyance direction by the document feeding unit 13.

To read a document placed on the platen glass 12b, the scanner 12a is moved to a position opposed to the platen glass 12b, reads the document placed on the platen glass 12b while scanning it to obtain image data, and then outputs the obtained image data to the main unit 14. To read a document fed by the document feeding unit 13, the scanner 12a is moved to a position opposed to the document reading slit 12c, reads the document in synchronization with a document conveying operation by the document feeding unit 13 via the document reading slit 12c to obtain image data, and then outputs the obtained image data to the main unit 14.

The document feeding unit 13 includes a document placing portion 13a, a document discharging unit 13b, and a document conveying mechanism 13c. A document placed on the document placing portion 13a is individually fed in sequence by the document conveying mechanism 13c, is conveyed to a position opposed to the document reading slit 12c, and then is discharged to the document discharging unit 13b. Note that the document feeding unit 13 is configured to be a collapsible; the top of the platen glass 12b can be opened by lifting the document feeding unit 13 upward.

The main unit 14 includes the image forming unit 17 as well as a paper sheet feeder 42, a paper sheet conveyance passage 43, the conveyance roller 44, and the discharge roller 45. The paper sheet feeder 42 includes a plurality of sheet feed cassettes 421, which stores different size or different direction of respective recording sheets, and the paper feed roller 422, which feeds a recording sheet one by one from the sheet feed cassette 421 to the paper sheet conveyance passage 43. The paper feed roller 422, the conveyance roller 44, and the discharge roller 45 function as a conveying unit. Recording sheets are conveyed by this conveying unit. The recording sheet conveyed to the paper sheet conveyance passage 43 by the paper feed roller 422 is fed to the image forming unit 17 by the conveyance roller 44. The recording sheet on which recording is performed by the image forming unit 17 is discharged to the stack tray 50 by the discharge roller 45.

The image forming unit 17 includes a photoreceptor drum 17a, an exposing unit 17b, a developing unit 17c, a transfer unit 17d, and a fixing unit 17e. The exposing unit 17b is an optical unit that includes a laser device, a mirror, a lens, an LED array, or a similar unit. The exposing unit 17b forms an electrostatic latent image on the surface of the photoreceptor drum 17a by emitting, for example, light in accordance with the image data and exposing the photoreceptor drum 17a. The developing unit 17c is a developing unit that develops an electrostatic latent image formed on the photoreceptor drum 17a using toner, and forms a toner image on the photoreceptor drum 17a in accordance with the electrostatic latent image. The transfer unit 17d transfers a toner image formed on the photoreceptor drum 17a by the developing unit 17c to the recording sheet. The fixing unit 17e heats the recording sheet on which the toner image is transferred by the transfer unit 17d to fix the toner image on the recording sheet.

### Individual Information Recordation Process by Image Forming Apparatus 1

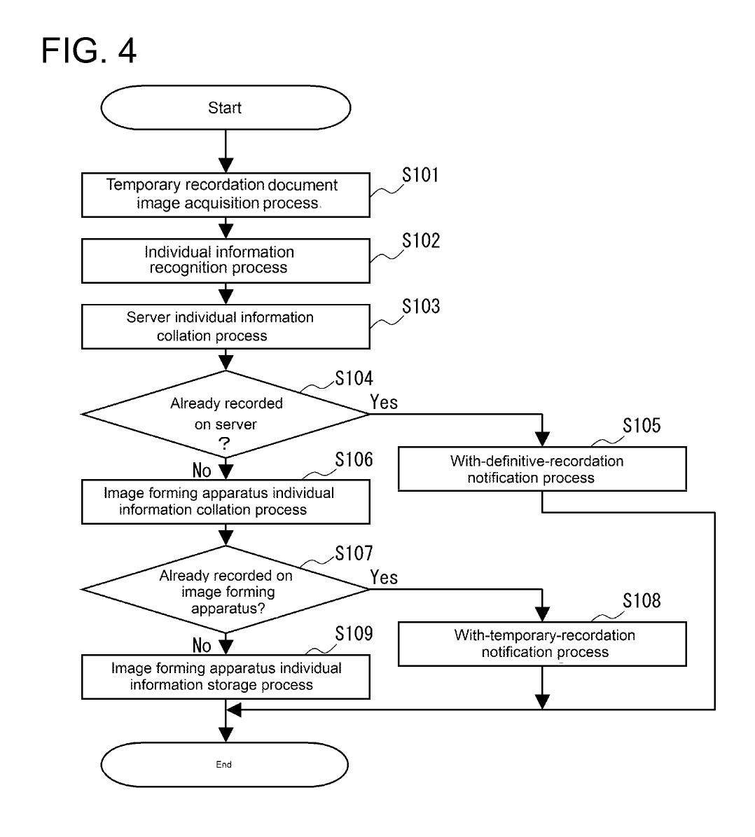

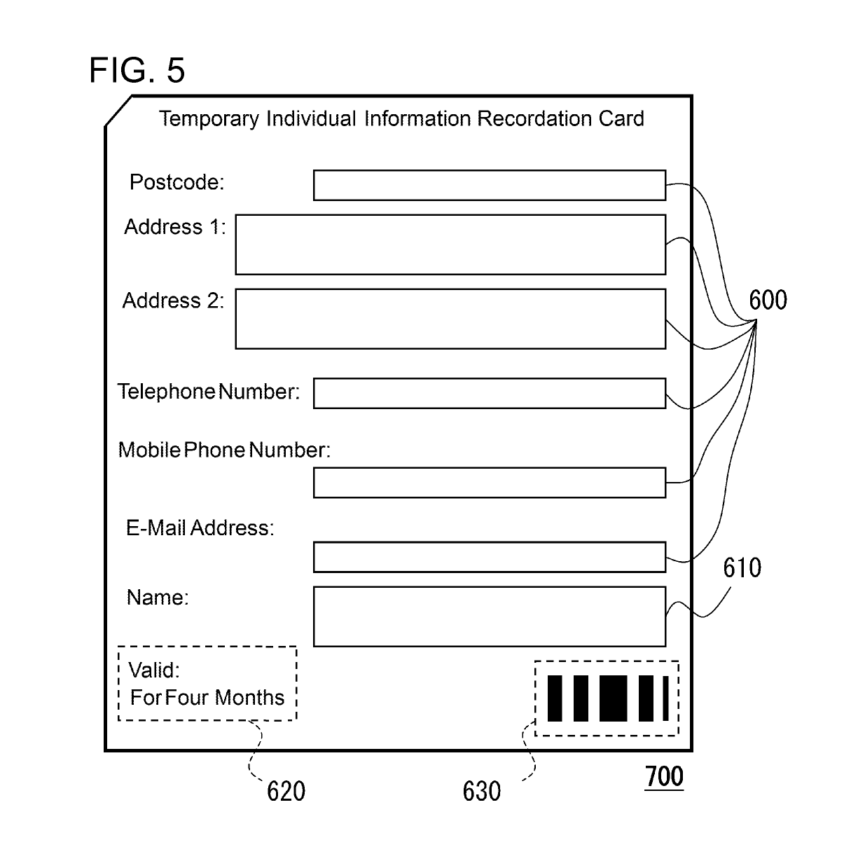

Here, with reference to FIGS. 4 and 5, the following describes an individual information recordation process according to the embodiment of the image forming apparatus 1 of the disclosure. When the user has a business talk or a similar talk where application of travel, a mobile phone, or similar application; or a contract of a vehicle, a house, or a similar purchase is required, the user needs to write the individual information by hand. The image forming apparatus 1 recognizes the character data 510 and the appraisal data 520 such as a handwriting and an imprint from the individual information written by hand by the user and once stores the data in the individual information storage unit 120 (hereinafter, this state is referred to as “temporary recordation”). In this respect, when the individual information has already been recorded in the server 3 and the image forming apparatus 1, the image forming apparatus 1 notifies the information. The control unit 18 mainly performs this process by executing a program or similar data stored in the storage unit 19 collaborating with respective units using hardware resources. The following describes an overview of the individual information recordation process in respective steps with reference to the flowchart in FIG. 4.

### Step S101

First, the control unit 18 performs a temporary recordation document image acquisition process by the document reading unit 12. With reference to FIG. 5, first, the user sets a document like a paper sheet example 700 of “a temporary individual information recordation card” on which individual information is written by hand to the document feeding unit 13. The user instructs execution of the temporary individual information recordation from the operation panel unit 16.

In the example of FIG. 5, the user writes the individual information by hand in entry columns 600. At least a part of the individual information may be already printed data. The user writes the name by hand, places a seal, or performs a similar operation in an entry column 610 for name. The signature space and the seal space may be provided separately. A retention period 620 includes a predetermined retention period during which the user's individual information is held. In the example of FIG. 5, “For Four Months” is specified as the predetermined retention period. The user may also specify this space by writing by hand. A barcode 630 indicates a type of the paper sheet example 700 by being printed in advance. The user can also specify the type with a check box or a similar method. The appraisal character recognition unit 11 optically recognizes these written and printed data as described later.

The control unit 18 obtains a user's instruction and causes the document reading unit 12 to read the set document. The image processor 10 image-processes the image data of the read document, and the image data storage unit 100 stores the image data as the image data 500.

The control unit 18 may obtain the image data 500 already existed in a connected recording medium, a user's storage folder (not illustrated) in the storage unit 19, or a similar storage, and may store the image data 500 in the image data storage unit 100. The control unit 18 may obtain an already-existed file from a storage folder in the server 3 or another terminal (not illustrated) as the image data 500 and may store the image data 500 in the image data storage unit 100. The control unit 18 may obtain the image data 500 from another image forming apparatus 1 or another server (not illustrated) over a network or may obtain a document received by facsimile or a similar document as the image data 500. FIG. 5 illustrates an example where a dedicated “temporary individual information recordation card” for recording the individual information first is employed as the paper sheet example 700, however, this should not be constructed in a limiting sense. For example, even a document for approval needs to be modified due to necessity of correction of an error or addition. If the document also contains individual information, the document can be employed for temporary recordation. In this respect, for example, a check space or a similar space may be formed for a type of paper sheet, or “For Temporary Recordation” or a similar description may be included in the predetermined entry column such that the image forming apparatus 1 may recognize the type of the paper sheet. The document such as an estimation, a first application form, or a similar document may be employed for temporary recordation as it is. The following configuration is also possible. When applying for another matter, having a business talk, or in a similar situation, the document on which previous individual information has been written may be employed for temporary recordation.

### Step S102

Next, the control unit 18 controls the individual information recognition unit 110 to perform an individual information recognition process. The control unit 18 controls the appraisal character recognition unit 11 to optically recognize the image data 500 stored in the image data storage unit 100 so as to obtain data required for transcription of individual information, an appraisal of handwriting and imprint, or a similar operation. The control unit 18 controls the appraisal character recognition unit 11 to identify the entry column on a frame, a table, or similar data. Then, the control unit 18 controls the appraisal character recognition unit 11 to recognize the character data 510 and the appraisal data 520 from the location written by hand by the user. The control unit 18 once stores the character data 510, which is recognized individual information, and the appraisal data 520 in the individual information storage unit 120. The control unit 18 may read out the format of paper sheet for temporary recordation stored in the storage unit 19 after controlling the appraisal character recognition unit 11 to recognize the type of document. Then, the control unit 18 may control the appraisal character recognition unit 11 to optically recognize only a specific position in the image data 500 such as the entry column.

### Step S103

Next, the control unit 18 controls the individual information recognition unit 110 to perform a server individual information collation process. The control unit 18 transmits the recognized character data 510 and appraisal data 520 to the definitive recordation individual information confirmation unit 320 of the server 3 as collation source data and causes the definitive recordation individual information confirmation unit 320 to collate whether the individual information has already been recorded on the server 3 or not. The definitive recordation individual information confirmation unit 320 of the server 3 uses the received user's appraisal data 520 as a collation source. The definitive recordation individual information confirmation unit 320 then collates whether or not any of the appraisal data 520 stored in the definitive recordation individual information storage unit 310 matches the collation source. This collation can be determined to be matched when, for example, homology and/or a statistic value of feature value are calculated, and the calculated values are within the predetermined range. When there is a match, the definitive recordation individual information confirmation unit 320 identifies the individual information. The definitive recordation individual information confirmation unit 320 of the server 3 transmits the collation result to the image forming apparatus 1. In this respect, when the character data 510 corresponding to the appraisal data 520 found to be matched by collation differs, the definitive recordation individual information confirmation unit 320 notifies the information.

### Step S104

Next, the control unit 18 controls the individual information recognition unit 110 to determine whether or not the individual information of the user has been already recorded in the definitive recordation individual information storage unit 310 of the server 3. When the individual information has been already stored in the definitive recordation individual information storage unit 310 of the server 3, the control unit 18 determines it as “Yes.” Otherwise, the control unit 18 determines it as “No.” If the determination is “Yes,” the control unit 18 advances the process to Step S105. If the determination is “No,” the control unit 18 advances the process to Step S106.

### Step S105

When the server 3 has already stored the individual information, the control unit 18 performs a with-definitive-recordation notification process by the individual information recognition unit 110. The control unit 18 controls the operation panel unit 16 to display “Individual information has already been recorded on the server 3.” or a similar message for notification to the user. Afterwards, the control unit 18 terminates the individual information recordation process.

### Step S106

When the server 3 does not store the individual information, the control unit 18 controls the individual information recognition unit 110 to perform an image forming apparatus individual information collation process. The control unit 18 sets the recognized appraisal data 520 as collation source data, collates the collation source data against the appraisal data 520 stored in the individual information storage unit 120, and identifies matching individual information. This collation can be performed similarly to the collation on the server 3 in Step S103.

### Step S107

Next, the control unit 18 controls the individual information recognition unit 110 to determine whether or not the individual information storage unit 120 has already recorded the individual information of the user. When the individual information storage unit 120 records the appraisal data 520 matched, the control unit 18 determines it as “Yes.” Otherwise, the control unit 18 determines it as “No.” If the determination is “Yes,” the control unit 18 advances the process to Step S108. If the determination is “No,” the control unit 18 advances the process to Step S109.

### Step S108

When the individual information storage unit 120 has already temporarily recorded the individual information of user, the control unit 18 controls the individual information recognition unit 110 to perform a with-temporary-recordation notification process. The control unit 18 controls the operation panel unit 16 to display “Individual information has already been temporarily recorded on the printer.” or a similar message for notification to the user. Afterwards, the control unit 18 terminates the individual information recordation process.

### Step S109

When both the individual information storage unit 120 and the server 3 do not record the individual information, the control unit 18 controls the individual information recognition unit 110 to perform an image forming apparatus individual information storage process. Here, the individual information of the user has not been temporarily recorded yet. Accordingly, the individual information storage unit 120, which is a database inside of the image forming apparatus 1, stores the recognized character data 510 and appraisal data 520, thus performing temporary recordation. At this point, the individual information is just temporarily recorded in the individual information storage unit 120 in the image forming apparatus 1 and, for example, not transmitted to the external server 3, and not recorded with the definitive recordation individual information storage unit 310. In view of this, another person cannot browse or use the individual information on the server 3, ensuring prevention of a leakage of individual information. Now the individual information recordation process according to the embodiment of the disclosure is terminated.

When the server 3 or image forming apparatus 1 has already recorded the individual information and the recognized character data 510 and the stored character data 510 differ, the control unit 18 can update the character data 510. In this case, the control unit 18 controls the operation panel unit 16 to display a dialog or a similar screen asking for whether to perform update or not. To update the character data 510 upon acceptance of this instruction, the character data 510 stored in the definitive recordation individual information storage unit 310 on the server 3 or in the individual information storage unit 120 of the image forming apparatus 1 is updated by the recognized character data 510. In this respect, the appraisal data 520 can also be updated.

### Definitive Recordation and Destruction Process by Image Forming Apparatus 1

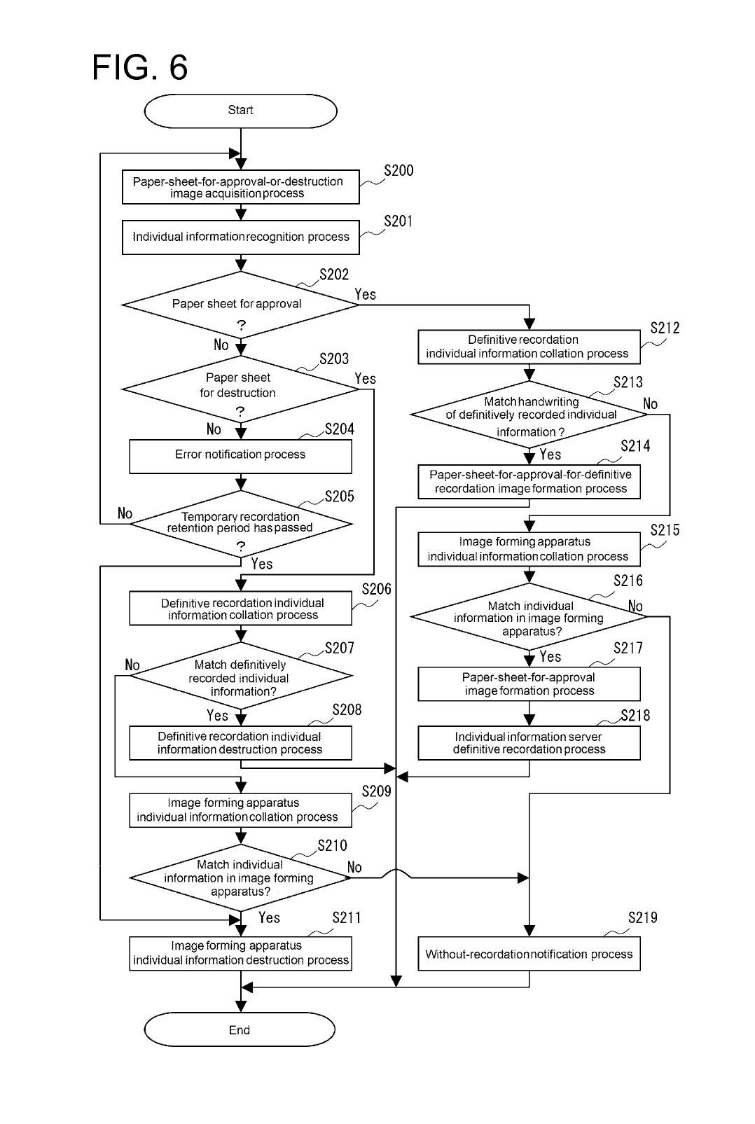

Next, with reference to FIG. 6 to FIG. 8, the following describes a definitive recordation and a destruction process according to the embodiment of the image forming apparatus 1 of the disclosure. In the definitive recordation and the destruction process, after temporary recordation, when the user signs a paper sheet for approval such as a final application form and a contract and causes the paper sheet to be read, the paper sheet is collated with the recorded appraisal data 520, thus the individual information is identified. When the individual information can be identified, the individual information is imaged on the paper sheet for approval and is recorded on the server 3. When the paper sheet for destruction of individual information is read, the paper sheet is collated with the recorded appraisal data 520 from the respective databases, and identified individual information is destroyed. If matching individual information cannot be collated, an error display or a similar display is performed. The control unit 18 mainly performs this process by executing a program stored in the storage unit 19 collaborating with the respective units using hardware resources. The following describes overviews of the definitive recordation and the destruction process in the respective steps with reference to the flowchart in FIG. 6.

### Step S200

First, the control unit 18 controls the approval-use paper-sheet-individual information identification unit 130 or the individual information destruction unit 140 to perform a paper-sheet-for-approval-or-destruction image acquisition process.

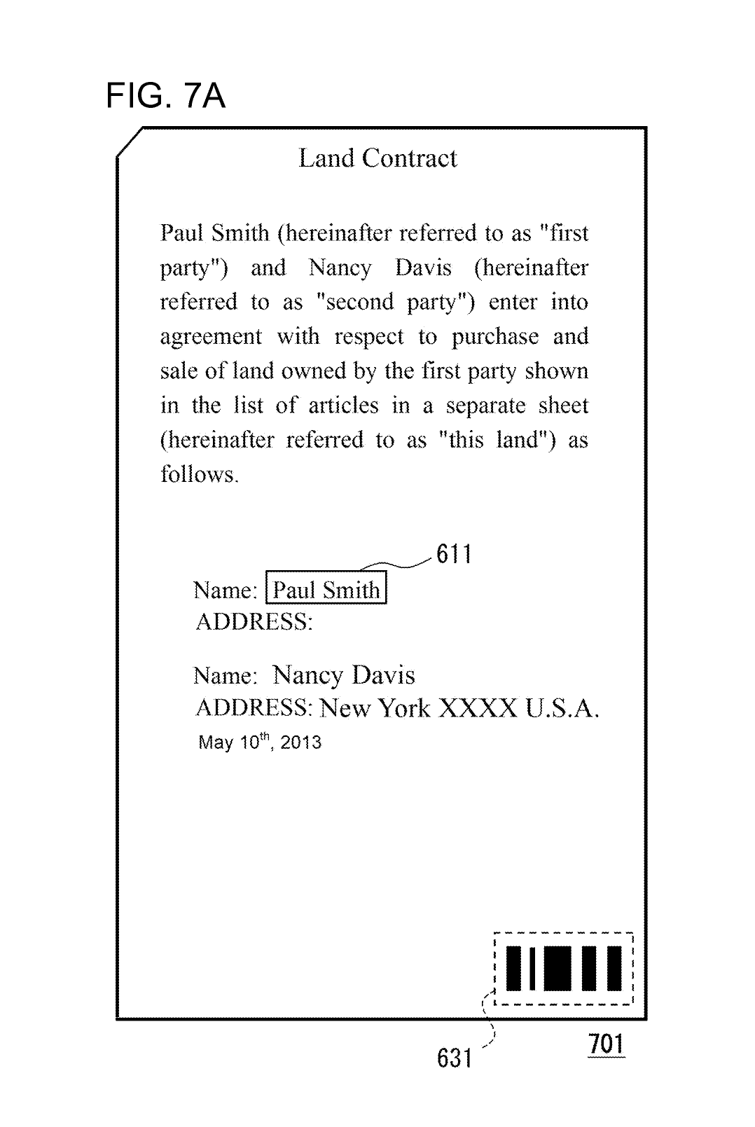

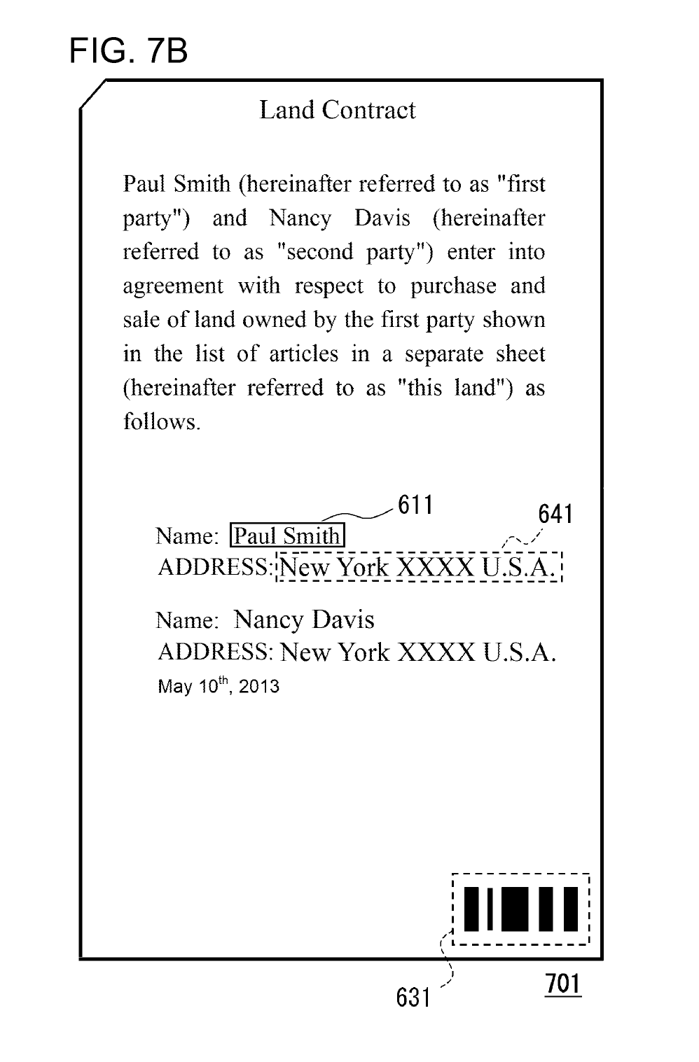

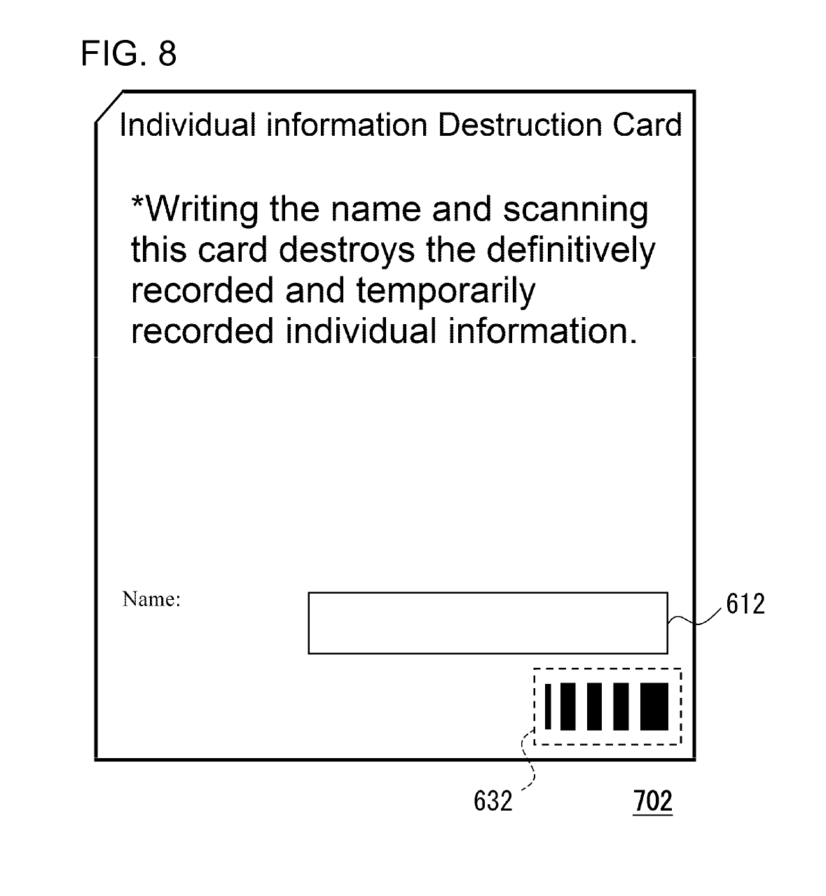

With reference to FIG. 7A, when an application, a business talk, or a similar situation is terminated and the document has no problem, the user writes the signature on the paper sheet for approval and causes the document reading unit 12 to read this paper sheet. In FIG. 7A, the user writes the name by hand, places the seal, or performs a similar operation on a signature space 611 in a paper sheet example 701. A barcode 631 indicates the type of the paper sheet example 701 by being printed in advance. With reference to FIG. 8, to destroy the individual information, the user writes the signature on the paper sheet for destruction of individual information and causes the document reading unit 12 to read the paper sheet. In FIG. 8, the user writes the name by hand, places the seal, or performs a similar operation in a signature space 612 in a paper sheet example 702. A barcode 632 also indicates the type of the paper sheet example 702 by being printed in advance. In the signature spaces 611 and 612, a signature space and a seal space may be created separately. The user can specify the type of paper sheet with a check box or a similar method as well. For example, selecting the predetermined entry column in the paper sheet for approval can make the paper sheet for approval as a substitution of paper sheet for destruction. The control unit 18 performs processes subsequent to a process such as reading, similarly to the temporary recordation document image acquisition process (see FIG. 4) in Step S101.

### Step S201

Next, the control unit 18 controls the approval-use paper-sheet-individual information identification unit 130 or the individual information destruction unit 140 to perform an individual information recognition process. The control unit 18 performs this process similarly to Step S102 (see FIG. 4).

### Step S202

Next, the control unit 18 controls the approval-use paper-sheet-individual information identification unit 130 to determine whether or not the read data is the paper sheet for approval. When the type of the paper sheet recognized from the image data 500 stored in the image data storage unit 100 is a paper sheet for approval and the paper sheet is signed, the control unit 18 determines it as “Yes.” Otherwise, the control unit 18 determines it as “No.” If the determination is “Yes,” the control unit 18 advances the process to Step S212. If the determination is “No,” the control unit 18 advances the process to Step S203.

### Step S203

If the read data is not the paper sheet for approval, the control unit 18 controls the individual information destruction unit 140 to determine whether or not the read data is the paper sheet for destruction. When the type of the paper sheet recognized from the image data 500 stored in the image data storage unit 100 is a paper sheet for destruction and the paper sheet is signed, the control unit 18 determines it as “Yes.” Otherwise, the control unit 18 determines it as “No.” If the determination is “Yes,” the control unit 18 advances the process to Step S206. If the determination is “No,” the control unit 18 advances the process to Step S204.

### Step S204

If the read data is not the paper sheet for approval or the paper sheet for destruction, the control unit 18 controls the approval-use paper-sheet-individual information identification unit 130 to perform an error notification process. The control unit 18 controls the display unit of the operation panel unit 16 or a similar display to display an error such as a failure of reading, no signature, or reading of different paper sheet. In this respect, when the control unit 18 detects that the user presses a cancel key or a similar key on the operation panel unit 16, the control unit 18 aborts reading and terminates the definitive recordation and the destruction process.

### Step S205

If the read data is not the paper sheet for approval or the paper sheet for destruction, the control unit 18 controls the individual information destruction unit 140 to determine whether or not the retention period during which temporary recordation is stored has passed. When the predetermined retention period has passed, the control unit 18 determines it as “Yes.” Otherwise, the control unit 18 determines it as “No.” If the determination is “Yes,” the control unit 18 advances the process to Step S211. If the determination is “No,” the control unit 18 returns the process to Step S200.

### Step S206

When the paper sheet for destruction is read, the control unit 18 controls the individual information destruction unit 140 to performs a definitive recordation individual information collation process. In this process, first, similarly to the server individual information collation process in Step S103 (see FIG. 4), the control unit 18 transmits the character data 510 and the appraisal data 520 recognized by the handwriting on the paper sheet for destruction or similar information to the definitive recordation individual information confirmation unit 320 of the server 3 as the collation source data, causes the definitive recordation individual information confirmation unit 320 to collate whether the individual information has been recorded on the server 3 or not, and obtains the result.

### Step S207

Next, the control unit 18 controls the individual information destruction unit 140 to determine whether or not the individual information matches the definitively recorded individual information. When the server 3 records the individual information that matches the appraisal data 520 of the collation source, the control unit 18 determines it as “Yes.” Otherwise, the control unit 18 determines it as “No.” If the determination is “Yes,” the control unit 18 advances the process to Step S208. If the determination is “No,” the control unit 18 advances the process to Step S209.

### Step S208

When the server 3 records the matching individual information, the control unit 18 controls the individual information destruction unit 140 to perform a definitive recordation individual information destruction process. The control unit 18 instructs the definitive recordation individual information confirmation unit 320 of the server 3 to destroy the individual information identified to be matched. The definitive recordation individual information confirmation unit 320 receives the instruction and deletes the image data 500, the character data 510, the appraisal data 520, or similar data corresponding to the collated individual information in the definitive recordation individual information storage unit 310. Thus, the individual information of the definitively recorded data can also be destroyed, thus achieving improvement of security. Afterwards, the control unit 18 terminates the definitive recordation and the destruction process.

### Step S209

The control unit 18 controls the individual information destruction unit 140 to perform the image forming apparatus individual information collation process. The control unit 18 performs this process similarly to Step S106 (see FIG. 4).

### Step S210

Next, the control unit 18 controls 120 the individual information destruction unit 140 to determine whether or not the individual information matches the individual information stored in the individual information storage unit. When the individual information storage unit 120 stores matched appraisal data 520, the control unit 18 determines it as “Yes.” Otherwise, the control unit 18 determines it as “No.” If the determination is “Yes,” the control unit 18 advances the process to Step S211. If the determination is “No,” the control unit 18 advances the process to Step S219.

### Step S211

When the individual information storage unit 120 stores the matched appraisal data 520 or the predetermined retention period has passed, the control unit 18 controls the individual information destruction unit 140 to perform an image forming apparatus individual information destruction process. The control unit 18 deletes the character data 510 of individual information and the appraisal data 520 stored in the individual information storage unit 120 and identified by found to be matched by the collation. That is, the control unit 18 destroys this temporarily recorded individual information. This reliably destroys the individual information temporarily recorded in the database in the image forming apparatus 1, thus improving security. Afterwards, the control unit 18 terminates the definitive recordation and the destruction process. If a predetermined storage period has passed, the control unit 18 may delete all corresponding data whose retention period for storing temporary recordation is passed.

### Step S212

Here, if the paper sheet is the paper sheet for approval, the control unit 18 controls the approval-use paper-sheet-individual information identification unit 130 to perform a definitive recordation individual information collation process. This process is performed similarly to Step S206.

### Step S213

When the signed paper sheet for approval is recognized, the control unit 18 controls the approval-use paper-sheet-individual information identification unit 130 to determine whether or not the paper sheet matches the definitively recorded individual information stored in the definitive recordation individual information storage unit 310. If the determination is “Yes,” that is, when matched, the control unit 18 advances the process to Step S214. If the determination is “No,” that is, when not matched, the control unit 18 advances the process to Step S215.

### Step S214

When the individual information matches the definitively recorded individual information, the control unit 18 controls the approval-use paper-sheet-individual information identification unit 130 to perform a paper-sheet-for-approval-for-definitive recordation image formation process. The control unit 18 instructs the definitive recordation individual information confirmation unit 320 of the server 3 to transmit the identified character data 510 of individual information stored in the definitive recordation individual information storage unit 310. With reference to FIG. 7B, when the control unit 18 obtains the character data 510, the control unit 18 instructs setting the paper sheet for approval to, for example, a bypass tray, with the display unit in the operation panel unit 16. When the control unit 18 accepts pressing of a start key or a similar key on the operation panel unit 16, the control unit 18 prints required information from the character data 510 to a predetermined position on the paper sheet for approval. In the example of FIG. 7B, the control unit 18 prints the individual information such as an address on a print space 641. Afterwards, the control unit 18 terminates the definitive recordation and the destruction process.

### Step S215

When the individual information does not match the definitively recorded individual information, the control unit 18 controls the approval-use paper-sheet-individual information identification unit 130 to perform the image forming apparatus individual information collation process. This process is also performed similarly to Step S209.

### Step S216

Next, the control unit 18 controls the approval-use paper-sheet-individual information identification unit 130 to determine whether or not there is the appraisal data 520 that matches the individual information stored in the individual information storage unit 120. If the determination is “Yes,” that is, when matched, the control unit 18 advances the process to Step S217. If the determination is “No,” that is, when not matched, the control unit 18 advances the process to Step S219.

### Step S217

When the appraisal data 520 matches the individual information stored in the individual information storage unit 120, the control unit 18 controls the approval-use paper-sheet-individual information identification unit 130 to perform a paper-sheet-for-approval image formation process. The control unit 18 first obtains the character data 510 of individual information matched and identified, from the individual information storage unit 120. Similarly to Step S214, the control unit 18 instructs the user to set the paper sheet for approval to, for example, a bypass tray, with the display unit in the operation panel unit 16, and accepts the user's pressing the start key or a similar key on the operation panel unit 16. When the control unit 18 accepts pressing of a start key or a similar key on the operation panel unit 16, the control unit 18 forms images of required information from the character data 510 at the predetermined position of the paper sheet for approval. This case also prints the individual information such as an address, for example, at the print space 641 as illustrated in FIG. 7B. Thus, even in a case of individual information after only the temporary recordation is completed, the control unit 18 prints the data after the collation with the appraisal data 520.

### Step S218

Next, the control unit 18 controls the approval-use paper-sheet-individual information identification unit 130 to perform an individual information server definitive recordation process. The control unit 18 transmits the image data 500 of the paper sheet for approval, the character data 510 of individual information and appraisal data 520 with individual information matched and identified, to the server 3. The definitive recordation individual information acquisition unit 300 of the server 3 obtains the image data 500, the character data 510 of individual information, and the appraisal data 520, and stores these data in the definitive recordation individual information storage unit 310. That is, signing by the user and scanning in the temporary recordation state allows the individual information to be definitively recorded after the contents of application, a business talk, or a similar situation is approved. After confirmation of the recordation on the server 3, the control unit 18 destroys the character data 510 and the appraisal data 520 from the individual information storage unit 120. Afterwards, the control unit 18 terminates the definitive recordation and the destruction process.

### Step S219

When both the server 3 and the individual information storage unit 120 do not store the matching individual information, the control unit 18 controls the approval-use paper-sheet-individual information identification unit 130 to perform a without-recordation notification process. The control unit 18 notifies error information such as “since the individual information does not match by collation, the definitive recordation and temporary recordation are not performed” on the operation panel unit 16 or a similar unit, and instructs execution of the temporary recordation first. Now the definitive recordation and the destruction process according to the embodiment of the disclosure are terminated.

With the configuration described above, the following effects can be provided. The image forming apparatus 1 according to the embodiment of the disclosure includes the document reading unit 12, the individual information recognition unit 110, the individual information storage unit 120, the approval-use paper-sheet-individual information identification unit 130, and the image forming unit 17. The document reading unit 12 is configured to read a paper sheet containing a space written into by hand as image data. The individual information recognition unit 110 is configured to recognize the character data 510 of individual information and the appraisal data 520 to identify individual information from the image data 500 of an individual information recordation space in the paper sheet for individual information recordation when a paper sheet read by the document reading unit 12 is for individual information recordation. The individual information storage unit 120 is configured to store the character data 510 of individual information and the appraisal data 520, which are recognized by the individual information recognition unit 110. The approval-use paper-sheet-personal-information identification unit 130 is configured to collate the image data 500 of a signature space on the paper sheet for approval against the appraisal data 520 stored in the individual information storage unit 120 when the paper sheet read by the document reading unit 12 is a paper sheet for approval to identify matching individual information. The image forming unit 17 is configured to image the character data 510 of identified individual information at a predetermined position on the paper sheet for approval when the individual information is identified by the approval-use paper-sheet-individual information identification unit 130. With this configuration, the image forming apparatus 1 once records the character data 510 of individual information and the appraisal data 520 such as handwriting and imprint. Then, the image forming apparatus 1 confirms the signed paper sheet for approval and then prints the individual information. In cases of application, a business talk, or a similar case, the content of the paper sheet can be confirmed with the entry locations of the individual information blank. In view of this, when a document is destroyed due to in need of an error correction or addition, the individual information is not described in the document to be destroyed. In view of this, a leakage of individual information can be reduced, thus ensuring improvement in security.

One technique cannot record individual information at the image forming apparatus. Accordingly, with this technique, in cases of application for travel or a similar purpose and a business talk on a vehicle, a house, or a similar purchase, when the user needs to write the individual information on a paper sheet such as an application form, an estimation, and a contract where individual information has been written, the individual information needs to be read from a storage medium every time. In contrast to this, it is only necessary for the image forming apparatus 1 of this embodiment to record individual information once. This ensures reducing a risk of a leakage of individual information due to hacking, skimming, or a similar accident during reading. Accordingly, this reduces security risk. Deleting the paper sheet for individual information recordation with a shredder or a similar machine ensures eliminating labor of management of individual information, thus ensuring cost reduction.

The above-described technique has a problem of cost increase when dealing with a paper sheet for special application form on which an IC chip is attached. In contrast to this, the image forming apparatus 1 of this embodiment does not require special equipment, thus ensuring cost reduction. In the above-described technique with a configuration of using a mobile phone or a similar mobile unit, the mobile phone needs to be always carried around for application and contract, thus causing a problem of poor usability. In contrast to this, the image forming apparatus 1 of this embodiment obtains the appraisal data 520 from individual information written by hand itself. This eliminates the need for special authentication equipment, ensuring improving usability and reducing the cost.

The image forming apparatus 1 according to the embodiment of the disclosure further includes the individual information destruction unit 140. The individual information destruction unit 140 is configured to destroy the character data 510 of individual information and the appraisal data 520 stored in the individual information storage unit 120 when a paper sheet read by the document reading unit 12 is for destruction of individual information, the image data 500 of a signature space on the paper sheet for destruction of individual information is collated against the appraisal data 520 stored in the individual information storage unit 120, and matching individual information has been identified. With this configuration, by scanning the signed paper sheet for destruction of individual information, the paper sheet is collated with the temporarily recorded appraisal data 520. If matched, the individual information is destroyed. In view of this, the user can reliably confirm that the temporarily recorded data is destroyed. This ensures reducing a risk of leakage of the individual information, a risk of use of the individual information for a direct mail, and a similar risk. Similarly, when the paper sheet with contents to be destroyed is scanned, the individual information destruction unit 140 collates the paper sheet against the appraisal data 520 definitively recorded on the server 3. If matched, the individual information definitively recorded in the definitive recordation individual information storage unit 310 can also be destroyed.

In the image forming apparatus 1 according to the embodiment, even when a predetermined retention period has elapsed from when the character data 510 of individual information and the appraisal data 520 are stored in the individual information storage unit 120, the individual information destruction unit 140 destroys the character data 510 and the appraisal data 520. This configuration destroys data after a lapse of predetermined time even if the data remains because that the user forgets scanning the paper sheet, or is falsified that the paper sheet was scanned. This can reliably destroy the temporarily recorded individual information. The individual information destruction unit 140 can also delete the individual information definitively recorded on the server 3 after a lapse of predetermined retention period.

In the image forming apparatus 1 according to the embodiment of the disclosure, the appraisal data 520 is handwriting data or imprint data. Even if the signature, the imprint, or a similar description is falsified, this configuration ensures indicating the falsification by the image forming apparatus 1, ensuring improvement of security. In particular, since signatures and imprints have a legal effect. Easily achieving determination of the falsification can reduce damages such as a fraud.

The server 3 according to the embodiment of the disclosure includes the definitive recordation individual information acquisition unit 300, the definitive recordation individual information storage unit 310, and the definitive recordation individual information confirmation unit 320. The definitive recordation individual information acquisition unit 300 is configured to obtain image data 500 of the paper sheet for approval, the character data 510 of individual information, and the appraisal data 520 from the image forming apparatus 1. The definitive recordation individual information storage unit 310 is configured to store the image data 500 of the paper sheet for approval, the character data 510 of individual information, and the appraisal data 520. The definitive recordation individual information confirmation unit 320 is configured to transmit the character data 510 of individual information and the appraisal data 520 to the image forming apparatus 1 when the definitive recordation individual information storage unit 310 has stored the character data 510 of individual information and the appraisal data 520 upon a query from individual information recognition unit 110, the individual information storage unit 120, the approval-use paper-sheet-individual information identification unit 130, and the individual information destruction unit 140 of the image forming apparatus 1. This ensures storing the image data 500, the appraisal data 520, and the character data 510 together with a time stamp or similar data. This can reduce a security risk due to a falsification of an application form, a contract, or a similar document.

Summarizing the above, the effects of the disclosure are as follows: i) Individual information can be read and temporarily recorded; ii) Approving temporarily recorded individual information ensures definitive recordation; iii) Individual information after the temporary recordation not required any longer can be intentionally destroyed; and iv) Individual information after the temporary recordation not required any longer can be automatically destroyed.

The above-described embodiment describes an example where the paper sheet for destruction is separately used; however, this should not be constructed in a limiting sense. That is, a configuration that destroys the individual information, which is definitively recorded or temporarily recorded, after a lapse of predetermined retention time is also possible. A configuration that destroys the individual information after scanning the paper sheet for personal recordation and the paper sheet for approval by a plurality of times is also possible. Appraisal by handwriting and imprint is employed as an example of the appraisal data 520 that identifies the individual information. However, the appraisal data 520 may be any data insofar as the data can be formed into image data for collation. For example, a radii ratio of predetermined diagram of cycloid or a similar value may be employed for the appraisal data 520.

The disclosure is also applicable to an information processing apparatus other than an image forming apparatus. That is, the disclosure may have a configuration using a server or a similar device to which a network scanner and a scanner are separately connected with a USB or a similar tool.

The configurations and operations of the embodiment are examples and these may be changed without departing from the scope of the disclosure.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. An image forming apparatus, comprising:
a document reading unit configured to read, as image data, a paper sheet containing a space written into by hand;
an individual-information recognition unit configured to recognize individual-information character data, and appraisal data in order to identify individual information, from image data in an individual-information recordation space on the paper sheet for individual-information recordation, when a paper sheet read by the document reading unit is for individual-information recordation;
an individual-information storage unit configured to store the individual-information character data of and the appraisal data recognized by the individual-information recognition unit;
a for-approval paper-sheet-individual-information identification unit configured to collate for-approval image data, in a signature space on the paper sheet, against the appraisal data stored in the individual-information storage unit, when a paper sheet read by the document reading unit is a paper sheet for approval, to identify matching individual information; and
an image forming unit configured to image the character data for identified individual information, in a for-approval predetermined position on the paper sheet, when individual information is identified by the for-approval paper-sheet-individual-information identification unit.

2. The image forming apparatus according to claim 1, further comprising an individual-information destruction unit configured to destroy the individual-information character data of and the appraisal data stored in the individual-information storage unit, when
a paper sheet read by the document reading unit is for destruction of individual information,
image data in a signature space on the paper sheet for destruction of individual information is collated against the appraisal data stored in the individual-information storage unit, and
matching individual information is identified.

3. The image forming apparatus according to claim 2, wherein the individual information destruction unit destroys the character data and the appraisal data at elapse of a predetermined retention period from when the individual-information character data and the appraisal data are stored in the individual-information storage unit.

4. The image forming apparatus according to claim 1, wherein the appraisal data is handwriting data or imprint data.

5. An image forming system, comprising:
the image forming apparatus according to claim 1; and
a server that includes:
a definitive-recordation individual-information acquisition unit configured to obtain the for-approval paper-sheet image data, the individual-information character data, and the appraisal data, from the image forming apparatus,
a definitive-recordation individual-information storage unit configured to store the for-approval paper-sheet image data, the individual-information character data, and the appraisal data, and
a definitive-recordation individual-information confirmation unit configured to transmit the individual-information character data and the appraisal data to the image forming apparatus upon a query from the image forming apparatus, when the definitive-recordation individual-information storage unit has stored the individual-information character data and the appraisal data.

6. An image forming method using an image forming apparatus, comprising:
reading, as image data, a paper sheet containing a space written into by hand;
recognizing individual-information character data, and appraisal data in order to identify individual information, from image data in an individual-information recordation space on the paper sheet for individual-information recordation, when the read paper sheet is for individual-information recordation;
storing the recognized individual-information character data of and appraisal data;
collating for-approval image data, in a signature space on the paper sheet, against the stored appraisal data, and identifying matching individual information, when a read paper sheet is for approval; and
imaging the character data for the identified individual information, in a for-approval predetermined position on the paper sheet, when the individual information is identified.

7. The image forming method according to claim 6, further comprising destroying the stored individual-information character data and appraisal data when
a read paper sheet is for destruction of individual information,
image data in a signature space on the paper sheet for destruction of individual information is collated against the stored appraisal data, and
matching individual information is identified.

8. The image forming method according to claim 7, wherein the destroying destroys the character data and the appraisal data at elapse of a predetermined retention period from when the individual-information character data and the appraisal data are stored.

9. The image forming method according to claim 6, wherein the appraisal data is handwriting data or imprint data.

10. A non-transitory computer-readable recording medium storing an image forming program, the image forming program causing a computer to function as:
a document reading unit that reads, as image data, a paper sheet containing a space written into by hand;
an individual-information recognition unit that recognizes individual-information character data and appraisal data in order to identify individual information, from image data in an individual-information recordation space on the paper sheet for individual-information recordation, when a paper sheet read by the document reading unit is for individual-information recordation;
an individual-information storage unit that stores the individual-information character data and the appraisal data recognized by the individual-information recognition unit;
a for-approval paper-sheet-individual-information identification unit that collates for-approval image data, in a signature space on the paper sheet, against the appraisal data stored in the individual-information storage unit, when a paper sheet read by the document reading unit is a paper sheet for approval, to identify matching individual information; and
an image forming unit that images the character data for identified individual information, in a for-approval predetermined position on the paper sheet, when individual information is identified by the for-approval paper-sheet-individual-information identification unit.

11. The non-transitory computer-readable recording medium according to claim 10, the image forming program further causing a computer to function as an individual information destruction unit that destroys the individual-information character data and the appraisal data stored in the individual-information storage unit, when
a paper sheet read by the document reading unit is for destruction of individual information,
image data in a signature space on the paper sheet for destruction of individual information is collated against the appraisal data stored in the individual information storage unit, and
matching individual information is identified.

12. The non-transitory computer-readable recording medium according to claim 11, wherein the individual information destruction unit destroys the character data and the appraisal data at elapse of a predetermined retention period from when the individual-information character data and the appraisal data are stored in the individual-information storage unit.

13. The non-transitory computer-readable recording medium according to claim 10, wherein the appraisal data is handwriting data or imprint data.
